(19) United States
(12) Patent Application Publication
(10) Pub. No.: US 2019/0362406 A1
(43) Pub. Date: Nov. 28, 2019

(54) EXECUTING DIGITAL ACTIONS IN A RETAIL ENVIRONMENT

(71) Applicant: International Business Machines Corporation, Armonk, NY (US)

(72) Inventors: Jeremy A. Greenberger, San Jose, CA (US); Lisa Seacat DeLuca, Baltimore, MD (US); Zachary Greenberger, Raleigh, NC (US)

(21) Appl. No.: 15/986,228

(22) Filed: May 22, 2018

(51) Int. Cl. G06Q 30/06

(52) U.S. Cl. CPC G06Q 30/0631; G06Q 30/0633

(57) ABSTRACT

A topic based conversation retrieval system and method may include receiving information related to a location or orientation of a user in a retail environment, determining the location or orientation of the user, determining a product of interest for the user based at least in part on the location or orientation of the user, where the determining occurs during a first visit by the user to the retail environment, and adding the product of interest to the list of products of interest to the user based on the received request.

### TECHNICAL FIELD

The present invention relates to systems and methods for executing digital actions in a retail environment. More specifically, the invention relates to systems and methods for performing updates to a digital wish list or want list of a user on a product that is proximate to where the user is standing.

### BACKGROUND

If a user today sees a product in a store and desires to save that product to a digital wish list or want list, the user would have to unlock their mobile device, open an application having their digital wish list, and search for the product in the application. Once the product is found, the user would then have to find the user interface within the application that adds the product to the wish list of the user.

### SUMMARY

An embodiment of the present invention relates to a method, and associated computer system and computer program product, for executing a digital action. One or more processors of a computer system receive information related to a location of a user in a retail environment. The one or more processors of the computer system determine the location or orientation of the user. The one or more processors of the computer system determine a product of interest for the user based at least in part on the location or orientation of the user, wherein the determining occurs during a first visit by the user to the retail environment. The one or more processors of the computer system add the product of interest to the list of products of interest to the user based on the received request.

### BRIEF DESCRIPTION OF THE DRAWINGS

FIG. 1 depicts a block diagram of a system for executing digital actions in a retail environment, in accordance with embodiments of the present invention.

FIG. 2 depicts a schematic view of a retail environment of the system for executing digital actions in a retail environment of FIG. 1, in accordance with embodiments of the present invention.

FIG. 3 depicts a perspective view of a mobile device located proximate a first shelf in a first location of the retail environment of FIG. 2, in accordance with embodiments of the present invention.

FIG. 4 depicts another perspective view of the mobile device located proximate the first shelf in the first location of the retail environment of FIG. 2, in accordance with embodiments of the present invention.

FIG. 5 depicts a flow chart of a method for executing digital actions in a retail environment, in accordance with embodiments of the present invention.

FIG. 6 depicts a flow chart of a method for executing digital actions in a retail environment, in accordance with embodiments of the present invention.

FIG. 7 depicts a block diagram of a computer system for the topic based collaborative recording and retrieving system of FIGS. 1-3, capable of implementing methods for executing digital actions in a retail environment of FIGS. 4-5, in accordance with embodiments of the present invention.

FIG. 8 depicts a cloud computing environment, in accordance with embodiments of the present invention.

FIG. 9 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

Users, such as shoppers, customers, patrons, or the like, are looking for fast and efficient ways to perform digital actions relative to products that they see, such as updating a digital wish list or want list, adding products of interest to a cart, or purchasing products of interest. If a user today sees a product in a store and desires to save that product to the digital wish of the user, the user would have to unlock their mobile device, open an application or web site (such as an Amazon® web site or application, for example) having the digital wish list of the user, and search for the product in the application. Once the product is found, the user would then have to find the user interface within the application that adds the product to the digital wish list of the user.

This process is problematic for users because the process for adding products to the wish list of the user is time consuming and requires multiple steps and/or interactions with the mobile device. A user may simply be too busy to take the steps required to update their digital wish list. Searching for the exact product becomes extremely problematic, as it is often difficult for a user to distinguish the exact product that is in front of them at the store, and the digital representation of the product in the application. Often times, many product offerings appear the same from their digital representations or product pages and a user might add an incorrect digital product to their wish list that does not exactly match the exact actual product that they found in the store.

Present methods further do not provide for an easy way for a user to create a digital registry. To create a registry, it is known to provide a shopper or user with a scanning device for scanning items that the shopper or user wishes to register for a special occasion, such as a wedding, baby shower or the like. Once the shopper scans or selects items, an additional step would be required to sync the selections of the shopper to a digital profile that corresponds to the shopper. Still further, existing methods of creating a registry at a retail location require the user to operate a UPC scanning device for selections. Existing technology today fails to provide for the ability to easily update or generate a wish list such as a registry by a mobile device owned and operated by the user or shopper.

Further, it is becoming more common for retailers to only include a floor model of items offered for sale where a purchase must be made digitally and sent by mail to the customer's home. With existing technology there is no simple way for shopping on a digital application while in a physical retail environment. Such scenarios require sales associates performing transactions at the request of users. Alternatively, a user could unilaterally perform the same process on the application or web site that requires unlocking their mobile device, opening and/or logging in to the application or web site, searching for the product, and making a purchase of the product. Again, this is a difficult process requiring multiple steps.

Thus, there is a need for methods and systems for executing digital actions in a retail environment, such as a retail environment, store, marketplace, dealership, grocery store, retail store, club, or the like, that improves the deficiencies known in the art. The present invention will help improve integration of the retail or commercial shopping experience with the digital shopping experience. When practiced, the present invention will result in an improvement in the shopping experience for users or shoppers. The present invention, when practiced, will result in an improvement in the marketing capabilities for companies. Further, the present invention will result in an improvement in computer technology by reducing computer resource usage because multiple steps will not need to be performed to accomplish the update of the wish list of a user, or purchase of a product. The present invention will also prevent unwanted products from ending up on the wish list of a user-unwanted products that do not correspond to the products the user actually encountered in person in a retail environment.

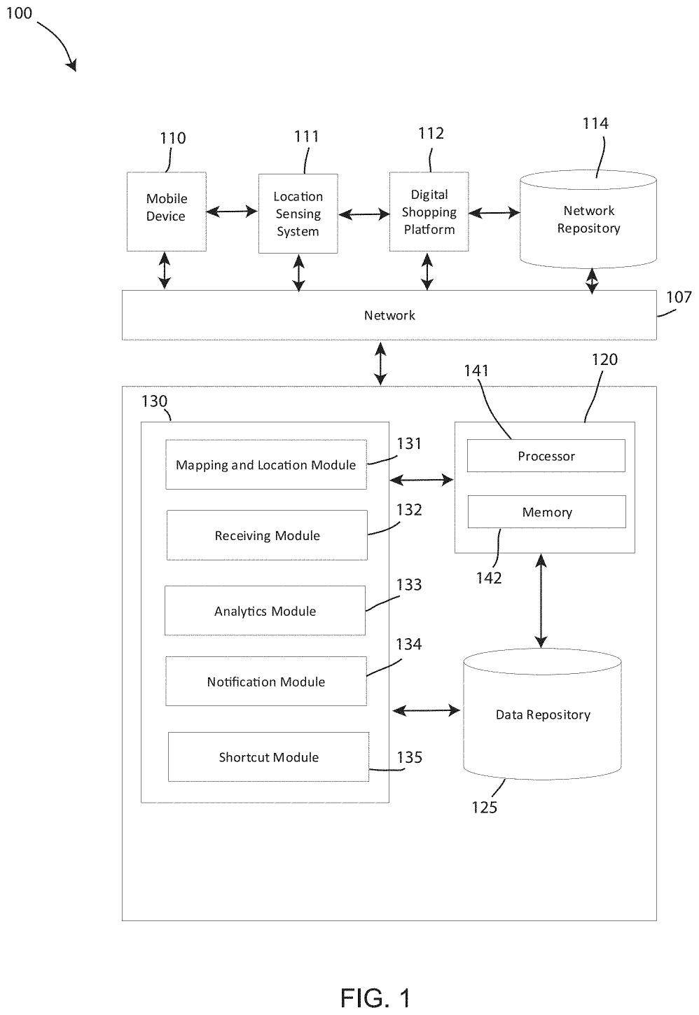

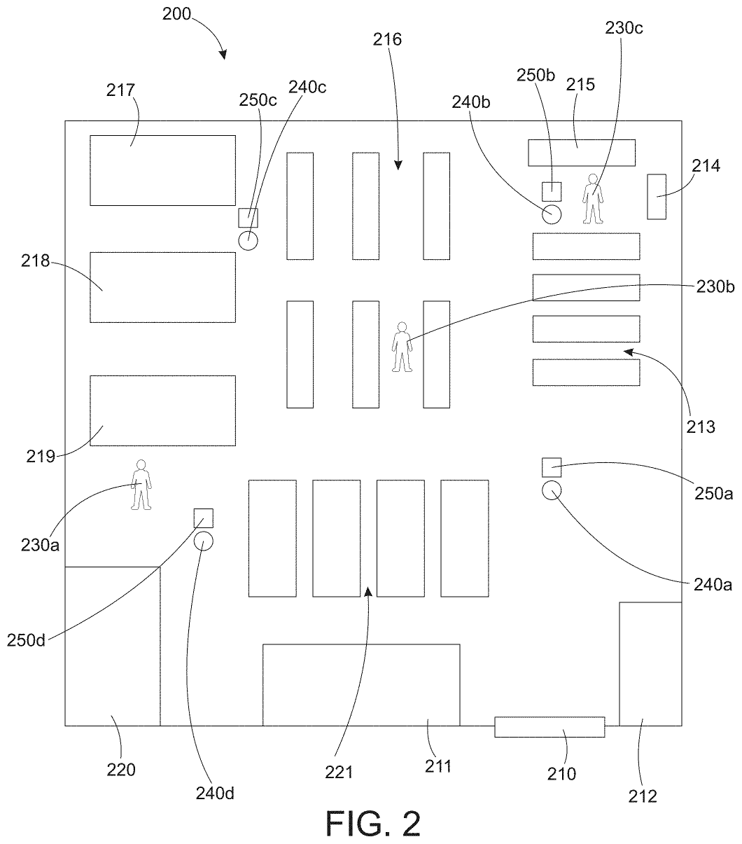

Referring to the drawings, FIG. 1 depicts a block diagram of a system for executing digital actions in a retail environment 100, in accordance with embodiments of the present invention. Embodiments of a system for executing digital actions in a retail environment 100 may be described as a system for performing updates to a digital wish list or want list of a user on a product that is proximate to where the user is standing. Embodiments of a system for executing digital actions in a retail environment 100 may be described as a system for adding products to a digital shopping cart or purchasing products. The system for executing digital actions in a retail environment 100 may obtain location information of a user from a location sensing system 111 within a retail environment (such as retail environment 200 shown in FIG. 2 and described in more detail herein below) and use this location information to provide notifications or content on a mobile device 110 of the user. Embodiments of the retail environment may be a store, a retailer, a retail environment, a salesfloor, a grocery store, a supermarket, a home goods store, a dealership, a gallery or any other location that invites customers to purchase items. As a user moves around the retail environment, the mobile device 110 of the user may be provided or presented with updates or options to add products proximate the location of the user to a wish list of the user. The system for executing digital actions in a retail environment 100 may obtain or receive requests from the user related to the products to update the digital wish list of the user, add the products to a digital shopping cart, or buy the products being presented to the mobile device 110 of the user.

Embodiments of the system for executing digital actions in a retail environment 100 may comprise a mobile device 110 communicatively coupled to a computer system 120 over a network 107. While only one mobile device 110 is shown, the number of mobile devices 110 connecting to computer system 120 over network 107 may vary from embodiment to embodiment. The number of mobile devices 110 may be dependent on the number of users located in the retail environment.

Embodiments of the mobile device 110 may include a computing device, such as a smartphone or tablet device, associated with or operated by the user. The mobile device 110 may also be a wearable device such as a smart watch or the like. The mobile device 110 may run various applications that contain data about the user. For example, a user's smartphone may be used as a sensor, and may also utilize the device's camera, microphone, and other embedded sensors to send information to the computer system 120. Moreover, the mobile device 100 may be communicatively coupled to the computer system 120, and may transmit information over a network 107. The mobile device 110 may include one or more hardware components for sending/receiving geolocation data of the mobile device 110. The mobile device 110 may include a number of input devices for providing or inputting information to computer system 120 over the network 107. For example, the mobile device 110 may include a Bluetooth system, or other transmitting system configured to provide information from the mobile device 110 into the system. Input devices of the mobile device 110 may include an accelerometer, a gyroscope, a GPS system, biometric sensor, a wearable sensor, a microphone, a peripheral device, or the like. Biometric sensors of the mobile device 110 may also include a heart rate monitor used to track a current or historical average heart rate of the user; wireless-enabled wearable technology, such as an activity tracker or smartwatch that tracks a heart rate; a blood pressure monitor; a perspiration sensor; and other wearable sensor hardware.

Information provided by the mobile device 110 to the computer system 120 may be location information acquired by the gyroscope, accelerometer or GPS system of the mobile device 110, or the other input devices of the mobile device 110. As shown in FIG. 1, the mobile device 110 may transmit data pertaining to a location, environmental information, micro-location data, answers to queries, identifying information, and the like, about the user or a movement of the user within the retail environment received or obtained from the mobile device 110 by connecting to computer system 120 over the network 107. Thus, the computer system 120 may receive the location information from the mobile device 110 which may be positioned within the retail environment. The mobile device 110 may also provide shortcut interaction commands to the computer system 120 such as when the user clicks on a graphical user interface option to add a product of interest to a wish list of products of interest of the user or adds a product of interest to a digital shopping cart, or places a purchase order for a product of interest.

A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120 and the mobile device 110, a connection to one or more network accessible knowledge bases containing information of one or more users, network repositories 114 or other systems connected to the network 107 that may be considered nodes of the network 107. In some embodiments, where the computer system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user data sent by the mobile device 110 and/or input device 111 to generate both historical and predictive reports regarding a user's purchasing habits, shopping habits, preferences, movement or navigational habits of the user through one or more retail environments. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

The system for executing digital actions in a retail environment 100 may include a location sensing system 111. The location sensing system 111 may include one or more sensing devices placed or located within the retail environment 200, in one embodiment, as described herein below. The location sensing system 111 may include one or more cameras positioned within the retail environment 200 shared by the user. The one or more environment cameras may capture location information of where the user is located in the retail environment 200. Further, the one or more cameras may capture additional information such as image data or video data of user, including a posture, facial expressions, perspiration, muscle activity, gestures, etc. Embodiments of the location sensing system 111 may also include one or more microphones positioned nearby the user to collect audio relating to the user, and other hardware input devices, such as an audio conversion device, digital camera or camcorder, voice recognition devices, graphics tablet, a webcam, VR equipment, mouse, touchpad, stylus, and the like, which may help provide data relating to an experience or movement of the user within the retail environment. The location sensing system 111 may include an environmental sensor, a camera, a camcorder, a facial recognition sensor or the like positioned in one or more aisles of a retail venue, voice capture device, and the like. In one embodiment, a sensor or camera may be located in each aisle of the retail environment. In other embodiment, sensors or cameras may be disposed throughout the retail environment so movement and monitoring of each aisle may be tracked or sensed.

The location sensing system 111 may transform an in-store customer experience by using intelligent location-based technology to engage patrons in near real-time to derive personal user data, including movements, traffic, etc. of the user while on the retail environment sales floor. Embodiments of the location sensing system 111 may detect the mobile device 110 when the mobile device 110 is communicating through radio signals using various protocols. In an exemplary embodiment, interface 180 may support Bluetooth Low Energy (BLE), Wi-Fi 802.11 on 2.4 GHz and 5 GHz radio communication protocols, for example. When a mobile device 110 is detected using one of the supported protocols, a Globally Unique Identifier (GUID) may be assigned for the mobile device 110. The GUID can be the MAC address for the device 110.

Accordingly, the mobile device 110 may be tracked by the location sensing system 111 as the mobile device 110 moves through the retail environment 200. All personally identifiable information (PII) including the MAC address or GUID may be encrypted by using a public key that is provided by the vendor to ensure that the customer data is secure. As the mobile device 110 moves through the retail venue, notifications can be triggered and sent enabling other back-office systems to take action, or may log a movement pattern throughout the retail venue. For instance, embodiments the location sensing system 111 may include pre-configured reports that analyze mobile device 110 movement inside a venue. Specifically, a trajectory and movement behavior of the owner of the mobile device 110 may be captured or otherwise collected, and may be placed into a context of sites and zone regions of the retail environment 200. The reports generated by the location sensing system 111, which may be received and/or processed by the receiving module 132 (described herein below), may enable sophisticated analysis of the retailer's customer data, such as movement patterns, site traffic, and owner preferences. As an example, the location sensing system 111 may obtain an average number of devices in a zone at any specified time, an average number of devices in the site at any specified time, how long the devices are staying in a particular zone at any specified time, how long the devices are staying in the site at any specified time, how many devices enter a particular zone on any specified date, and an overall number of devices that enter the site on any specified date, a number of devices, new versus repeating, that enter the site at any specified time. An exemplary embodiment of the intelligent location-based technology interface may be IBM® Presence Insights. Therefore, embodiments of the receiving module 132 may communicate with the location sensing system 111 to obtain micro-location data, which may be used by the system for executing digital actions in a retail environment 100 to process and analyze location information.

Still further, the location sensing system 111 may be configured to sense the location of a user relative to a particular product in the retail environment. For example, the location sensing system 111 may include RFID chips located in products configured to interact with the mobile device and sense when the mobile device is proximate the products. This may provide location information to the computer system 120 necessary to trigger the system providing notifications related to the product to the mobile device 110, as described herein below, without the computer system 120 necessarily knowing the exact location of the user in the retail environment.

The system for executing digital actions in a retail environment 100 may further include a digital shopping platform 112. The digital shopping platform 112 may include a web site, an application or the like. The digital shopping platform 112 may be a website owned by or corresponding to the particular retail location or store that the location sensing system 111 is located. For example, if the system for executing digital actions in a retail environment 100 is implemented in a Barnes & Noble® retail venue or store, the digital shopping platform 112 may be the Barnes & Noble® website. In other embodiments, the digital shopping platform 112 may be a separate digital vendor, such as the Amazon® website. Whatever the embodiment, the digital shopping platform 112 may be configured to allow a user to create and/or update a wish list or want list. The digital shopping platform 112 may be configured to allow a user to create a shopping cart and ultimately purchase an item or product such that the item or product is delivered to an address specified by the user.

Embodiments of the computer system 120 may include a mapping and location module 131, a receiving module 132, an analytics module 133, a notification module 134, and a shortcut module 135. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the mapping and location module 131 may include one or more components of hardware and/or software program code for creating a digital map of the retail environment 200. The mapping and location module 131 utilize information related to the floor layout of the retail environment 200, such as where items or products are located on the floor of the retail environment 200. For example, the mapping and location module 131 may utilize information related to each shelf in the retail environment and what products are located on each shelf as well as where each product is located on the shelf. The mapping and location module 131 may provide a digital map of the retail environment 200 so that the exact physical locations of the products in the retail environment 200 are known by the computer system 120. This mapping and location module 131 may include a user interface so that a user may be configured to enter information related to each product and where the product is located. In other embodiments, the mapping and location module 131 may include sensors in the shelves and/or aisles in the retail environment 200 for automatically detecting where the products are located in the retail environment 200 and providing this information to the mapping and location module 131. The sensors may include any of the types of sensors described herein above with respect to the location sensing system 111. However, these sensors may be configured to locate products in the retail environment 200 rather than users or customers. In still other embodiments, a combination of sensors and/or manual input information may be utilized to generate a map of products in the retail location. Data pertaining to the location of products in the retail environment 200 may be located in the data repository 125 which is in communication with the mapping and location module 131.

The mapping and location module 131 may enable the input or receiving of information related to only a subset of the products in the retail environment. For example, if the retailer would like to advertise only a subset of the products using the computer system 120, it is possible to only include or map a subset of the total products on the retail floor in the computer system 120. This may enable a retailer to provide notifications to users only related to a specific subset of the products being sold by the retailer. Whatever the embodiment, the mapping and location module 131 may provide a module for mapping products contained in the retail environment 200 which can be utilized by the computer system 120 as described herein below.

Embodiments of the receiving module 132 may include one or more components of hardware and/or software program code for obtaining, retrieving, collecting, or otherwise receiving information the location sensing system 111. In an exemplary embodiment, the receiving module 132 receives location data, micro-location data, and location-related metadata about the user from the location sensing system 111, when the user is present in a retail environment 200, such as a salesfloor of a retailer (e.g. micro-location data). The micro-location data may be used to build a context that can be used for analysis and resulting actions by the analytics module 133, the notification module 134 and the shortcut module 135. For example, location data may capture a physical path a user takes through the retail environment 200. Embodiments of the receiving module 132 may communicate with the location sensing system 111 to obtain or otherwise receive the micro-location data of the user. Embodiments of the location sensing system 111 may be a component of the computer system 120, or may be external to the computer system 120, and connected to the computer system 120 over network 107. The receiving module 132 may provide information received by the computer system 120 from the mobile device 110 to be stored in the data repository 125.

In addition to receiving information from the location sensing system 111, the receiving module 132 may be configured for receiving information directly from the mobile device 110 regarding, for example, the location of the mobile device 110. For example, the receiving module 132 may receive user data from the mobile device 110, when the mobile device 110 enters or leaves the retail environment 200. The mobile device 110 may be configured to provide orientation information to the receiving module 132. Orientation information may be information related to the location of the mobile device 110 within the retail environment 200 including the exact location and orientation of the mobile device 110. This orientation information may be sensed by a gyroscope or accelerometer, or GPS system of the mobile device 110, for example. The receiving module 132 may provide information received by the computer system 120 from the location sensing system 111 to be stored in the data repository 125. The receiving module 132 may further receive command information from the mobile device 110 such as requests or responses to inquiries that would result in the product of interest being added to a wish list, shopping cart or purchased by the user.

Referring still to FIG. 1, embodiments of the computer system 120 may further include an analytics module 133 for analyzing and determining the location of the user in the retail environment 200. Embodiments of the analytics module 133 may refer to configurations of hardware, software program code, or combinations of hardware and software programs, capable of analyzing data received from the mobile device 110 and/or the location sensing system 111 to determine a location of the user relative to products in the retail environment. Embodiments of the analytics module 133 may ascertain a product of interest to the user based at least in part on the location or orientation of the user in the retail environment 200. For instance, the analytics module 133 may take information received by the receiving module 132 related to the location of the user in the retail environment 200 and compare this location to the information contained in the mapping and locating module 131. The analytics module 133 may then determine which products the user is proximate based on this comparison.

The analytics module 133 may be further configured to determine whether the user is at the retail environment 200 for the first time. Alternatively, the analytics module 133 may be configured to determine whether the user has been at the retail environment in the past. The analytics module 133 may be configured to determine the number of times the user has entered into the retail environment, or a retail environment owned by the same retailer. This determination may be based on information received from the mobile device 110 of the user interacting with the location sensing system 111. The analytics module 133 may perform different methodology depending if a user has been at the retail environment 200 before.

The analytics module 133 may be in communication with the digital shopping platform 112 to determine whether the user has not yet purchased the product of interest on the user interface, application or web site provided by the digital shopping platform 112. Alternatively, the analytics module 133 may be configured to determine that the user has purchased the product of interest on the user interface, application or web site provided by the digital shopping platform 112.

Still further, the analytics module 133 may be configured to determine whether the user is holding their mobile device 110 within a threshold distance to a particular product in the retail environment 200 for a predetermined period of time or the product has been interacted with for a predetermined period of time by the user. For example, if the user holds their mobile device 110 next to a particular product, the mobile device 110 and the location sensing system 111 may be configured to determine this interaction. Once it is determined that the user is holding the mobile device 110 within the threshold distance of a product, the analytics module 133 may direct the notification module 134 and/or shortcut module 135 to provide a selection to the mobile device 110 related to the particular product. In still other embodiments, the analytics module 133 may be configured to determine whether the user is simply picking up a particular product, regardless of proximity of the product to the mobile device 110. Still further, the analytics module 133 may be configured to determine whether a user is focused on the particular product, looking at a particular product, or otherwise interacting with the particular product, without even physically touching the product.

The analytics module 133 may be configured to determine whether a user has responded to a query or provided a command to the computer system 120 to, for example, add a product of interest to a wish list, digital shopping cart, or place a digital purchase order. The analytics module 133 may be configured to analyze such commands or query responses and send the appropriate information to the digital shopping platform 112.

With continued reference to FIG. 1, embodiments of the computer system 120 may include a notification module 134. Embodiments of the notification module 134 may include one or more components of hardware and/or software program code for selecting, notifying, or providing a product pop-up or selection to the display of the mobile device 110. For instance, embodiments of the notification module 134 may be configured to present via a display of the mobile device 110, the user with a graphical depiction of the product of interest The notification module 134 may operate in tandem with the mapping and location module 131, the receiving module 132 and the analytics module 133 to provide users with the presentation of the products based on the proximity of the user to the actual product in the retail environment, and the location of the user as described herein above. For example, the notification module 134 may provide a product notification on the display of the mobile device 110 when the user is located proximate a product in the retail environment. The notification module 134 may be configured to provide a notification of a product on the display of the mobile device 110 only after a predetermined threshold has been met while the user is moving around in the retail environment 200. For example, the notification module 134 may be configured to provide a new product on the display of the mobile device 110 only if a person moves at least 10 feet within the retail environment 200 from the last location where a product was provided by the notification module to 134 to the display of the mobile device 110. Other thresholds may be utilized by the notification module such as a timing threshold. For example, a new product may only be provided to the display of the mobile device 110 after a predetermined period of time has passed (e.g. 10 seconds) from the last product update by the notification module 134. The notification module 134 may provide more than one product to the display of the mobile device 110. For example, the notification module 134 may provide multiple products that are visually displayed in the same orientation and manner as the products are actually displayed on the physical shelves in the retail environment. The notification module 134 may be configured to provide a scrolling display of products as the person moves around in the retail environment 200 such that products displayed on the mobile device correspond to the products proximate the user in the retail environment 200.

With continued reference to FIG. 1, embodiments of the computer system 120 may include a shortcut module 135. Embodiments of the shortcut module 135 may include one or more components of hardware and/or software program code for providing a shortcut interaction on the mobile device 110 for performing a command, function or interaction on the digital shopping platform 112. The shortcut module 135 may be configured to present a graphical user interface option to add the product of interest to a wish list or want list of products of interest of the user on the digital shopping platform 112. Still further, the shortcut module 135 may be configured to present other graphical user interface options such as a graphical user interface option to add the product of interest to a cart, or an option to purchase the product of interest. These graphical user interface options may be configured to provide a shortcut for the user to perform a digital action while in the retail environment on, for example, the digital shopping platform 112. For example, the shortcut module 135 may provide a single click interface whereby a user can perform an action such as purchase a product of interest, put a product of interest in a digital shopping cart, or place a product of interest on a want list or wish list or favorite list, with a single click of the graphical user interface option. In other embodiments the graphical user interface option, when clicked, would navigate the user immediately to a website, or application screen that would allow a user to immediately perform the desired digital action. The shortcut module 135 may integrate with the notification module 134 in instances where multiple product notifications are displayed on the display of the mobile device 110. In these instances, the user may be required to click on the specific product of the products displayed that the user wishes to perform the digital action on. Once clicked, the product may be highlighted in some manner, either by color, expanding the size of the product or the like. The shortcut module 135 may provide the one or more shortcut options of digital actions that the user can perform with respect to whatever product was selected of the plurality of displayed products.

The shortcut module 135 and/or the notification module 134 may be configured to alert a second user that a first user updated their wish list using the system for executing digital actions in a retail environment 100. The shortcut module 135 and/or the notification module 134 may provide appropriate notifications and shortcut options to the second user based on the interactions of the first user. For example, two users may wish to link their accounts in the computer system 120 such that updates to a wish list by one user would be seen by the second user or would even update the wish list of the second user.

Referring still to FIG. 1, embodiments of the computer system 120 may be equipped with a memory device 142 which may store the location information, information related to the number of times a user has entered into a particular retail environment, mapping information, product information, and the like, and a processor 141 for implementing the tasks associated with the system for performing a digital action in a retail environment 100.

FIG. 2 depicts a schematic view of a retail environment 200 of the system for executing digital actions in a retail environment 100, in accordance with embodiments of the present invention. The retail environment 200 may include various features such as a door or store opening 210, an office space 211, a cart storage location 212, a clothing retail space 213, electronic retail space 214, pharmaceutical or health retail space 215, food and drink retail space 216, fresh fruit and vegetable space 217, a bakery 218, a seafood retail space 219, bathrooms 220, and the like. The retail environment 200 is shown including three users 230a, 230b, 230c at various locations in the retail environment 200.

The retail environment 200 further includes four cameras 240a, 240b, 240c, 240d located throughout the environment. The cameras 240a, 240b, 240c, 240d may be positioned such that the entirety of the retail environment 200 may be seen by at least one camera. Similarly, a beaconing system 250a, 250b, 250c, 250d is shown. The beaconing system 250a, 250b, 250c, 250d may include a plurality of beacons for utilization by a system such as IBM Presence Insights®, as described hereinabove. Thus, the beacons 250a, 250b, 250c, 250d and the cameras 240a, 240b, 240c, 240d may comprise sensors of the location sensing system 111. Various other sensors are contemplated but not shown, as described hereinabove. As the users 130a, 130b, 130c walk around the retail environment 200, the location sensing system 111 including the beacons 250a, 250b, 250c, 250d and the cameras 240a, 240b, 240c, 240d may determine the location. The products in the various product spaces 213, 214, 215, 216, 217, 218, 219 may each be mapped by the mapping and location module 131.

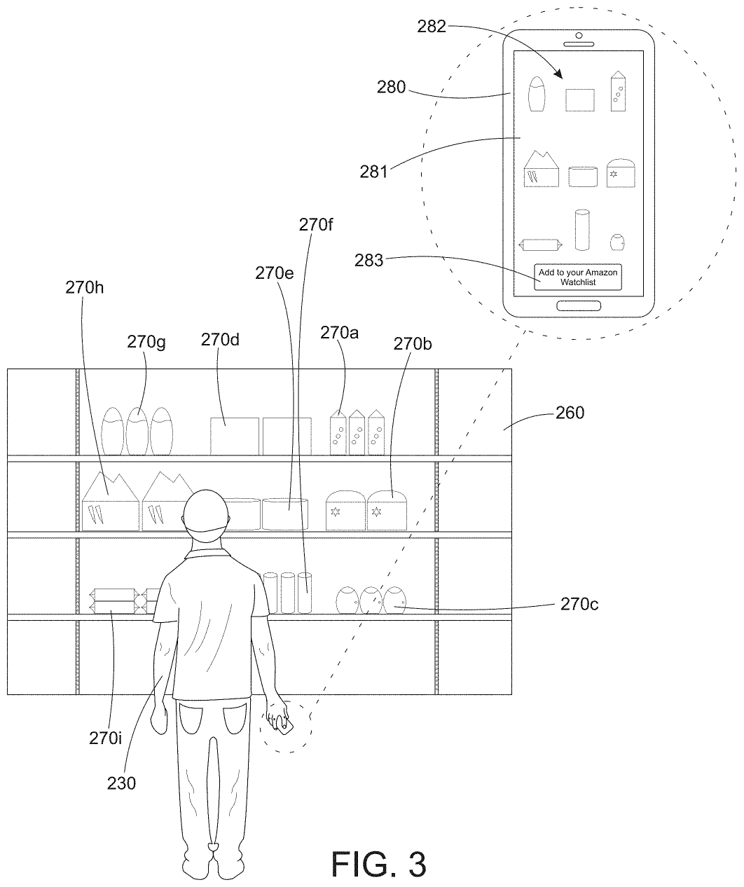

FIG. 3 depicts a perspective view of a mobile device 280 located proximate a first shelf 260 in first location of the retail environment 200, in accordance with embodiments of the present invention. One of the users 230 is shown proximate the first shelf 260. The first shelf may be in one of the various product spaces 213, 214, 215, 216, 217, 218, 219 described hereinabove. The first shelf includes a plurality of products 270a, 270b, 270c, 270d, 270e, 270f, 270g, 270h, 270i displayed thereon.

The user 230 is shown holding the mobile device 280. The face of the mobile device 280 is shown in an expanded state, having a display 281. A plurality of products 282 are shown on the display 281 corresponding to the products 270a, 270b, 270c, 270d, 270e, 270f, 270g, 270h, 270i located the shelf. In this embodiment, the products are displayed on the display 281 in a manner that is consistent with the location of the products 270a, 270b, 270c, 270d, 270e, 270f, 270g, 270h, 270i on the shelf 260. A shortcut graphical user interface option 283 is shown allowing the user to add a product to an Amazon® wish list. Thus, in this embodiment, Amazon® is the digital shopping platform 112. While the shortcut 283 to add to the wish list is shown, other shortcuts are contemplated such as adding the product to a shopping cart or purchasing the product on the digital shopping platform 112. It is contemplated that the products on the display 281 may scroll forward as the user walks forward down the aisle along the shelf 260 and may scroll backward as the user walks backward down the aisle along the shelf 260.

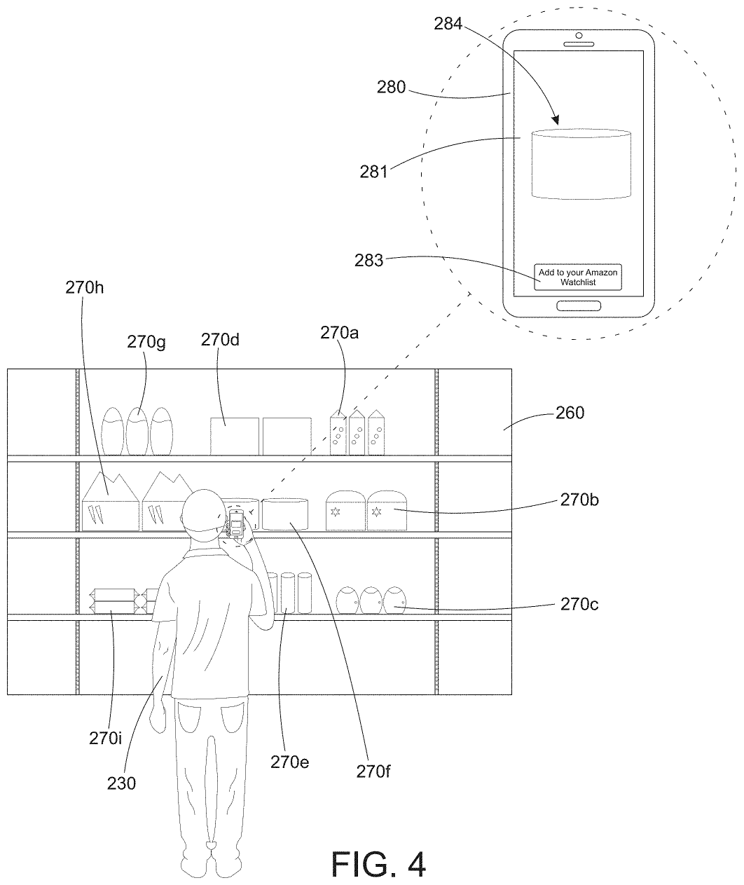

FIG. 4 depicts another perspective view of a mobile device 280 located proximate the first shelf 260 in the first location of the retail environment 200, in accordance with embodiments of the present invention. Unlike FIG. 3, the user 230 is holding the mobile device 280 within a threshold distance to a particular product 270f for a predetermined period of time in the embodiment shown. As shown on the display 281 of the mobile device 280, the particular product 284 is shown corresponding to the particular product 270f that the user is holding the mobile device 280 proximate. The threshold distance may be less than 6 inches, or a foot or the like. The predetermined period of time may be 3 seconds, 5 seconds, or 1 second, for example.

While the embodiment described hereinabove relates to a traditional store, such as a grocery store, the retail environment 200 may be any environment where products are offered for sale, or whereby products of interest may be provided to the mobile device of the user. For example, the mobile device 110 may be a device integrated into the console of a vehicle. Thus, the retail environment may be a roadway or other location capable of travel, whereby the mobile device receives information related to products that are being passed by in the vehicle. For example, the console display (i.e. the mobile device) of the vehicle may receive information related to a commercial location (i.e. house for sale, or restaurant of interest) proximate the vehicle based on a location sensing system 111 such as GPS of the vehicle sensing that the user is located next to the commercial location.

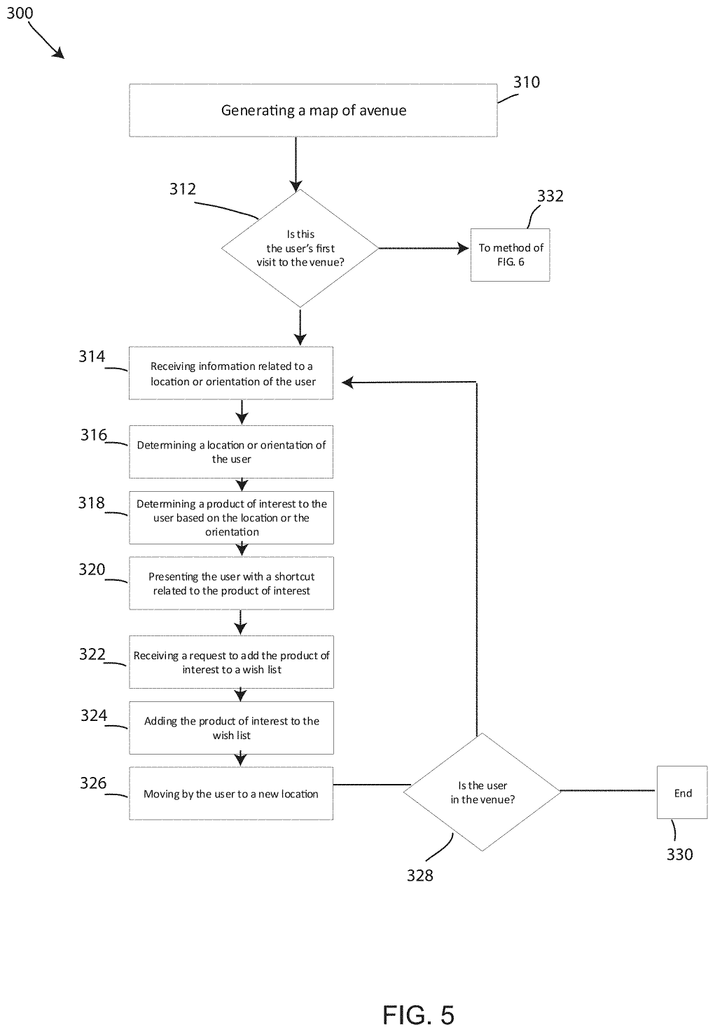

FIG. 5 depicts a flow chart of a method 300 for executing digital actions in a retail environment, in accordance with embodiments of the present invention. The method 300 may include a first step 310 of generating a map of the venue, such as the retail environment 200, by the one or more computer processors, that indicates locations of one or more products of interest based at least in part by the location or orientation of the user. The method 300 may include a next step 312 of determining whether this is the first visit of a user to the venue or retail location. If it is determined that this is not the first visit of the user to the venue or retail location, the method 300 may proceed to the method 400 described herein below. If it is determined that it is the first visit of the user to the venue or retail location, the method 300 may proceed to the next step 314 of receiving information related to a location or orientation of the user in the retail environment or venue by, for example, the location sensing system 111.

The method may then proceed to a next step 316 of determining a location or orientation of the user in the retail environment or venue by, for example, the analytics module 133 interacting with information received by the receiving module 132. The method may then proceed to a next step 318 of determining a product of interest to the user based at least in part on the location or the orientation of the user in the retail environment, for example a location or orientation relative to the product by. Step 318 may be accomplished, for example, by the analytics module 133 interacting with information provided or processed by the mapping and location module 131 and the receiving module 132. The step 318 may include determining a selection of an item for inclusion in the list of products of interest to the user based on the determination that the mobile device has been held within a threshold distance to a product for a predetermined period of time by the user.

The method 300 may include a next step 320 of presenting the user with a shortcut or other graphical user interface option related to a product of interest to add the product of interest to a wish list of products of interest to the user by, for example, the shortcut module 135 and the notification module 134. The method 300 may include a next step 322 of receiving a request to add the product of interest to a wish list or list of products of interest to the user by, for example, an interaction with a shortcut provided by the shortcut module 135. The method 300 may include a next step 324 of adding the product of interest to the wish list or list of products of interest to the user by, for example, the shortcut module 135 interacting with the digital shopping platform 112. The method 300 may include a next step 326 of moving, by the user, to a new location or orientation in the retail environment or venue. The next step 326 may include determining that the user remains in the retail venue by, for example, the analytics module taking information received by the receiving module 132 from the mobile device 110 and/or the location sensing system 111. If the method 300 determines that the user remains in the retail environment, the method 300 may revert to step 314 of receiving information related to a location or orientation of the user in the venue. If the method determines that the user has left the retail environment, the method may include an end step 330.

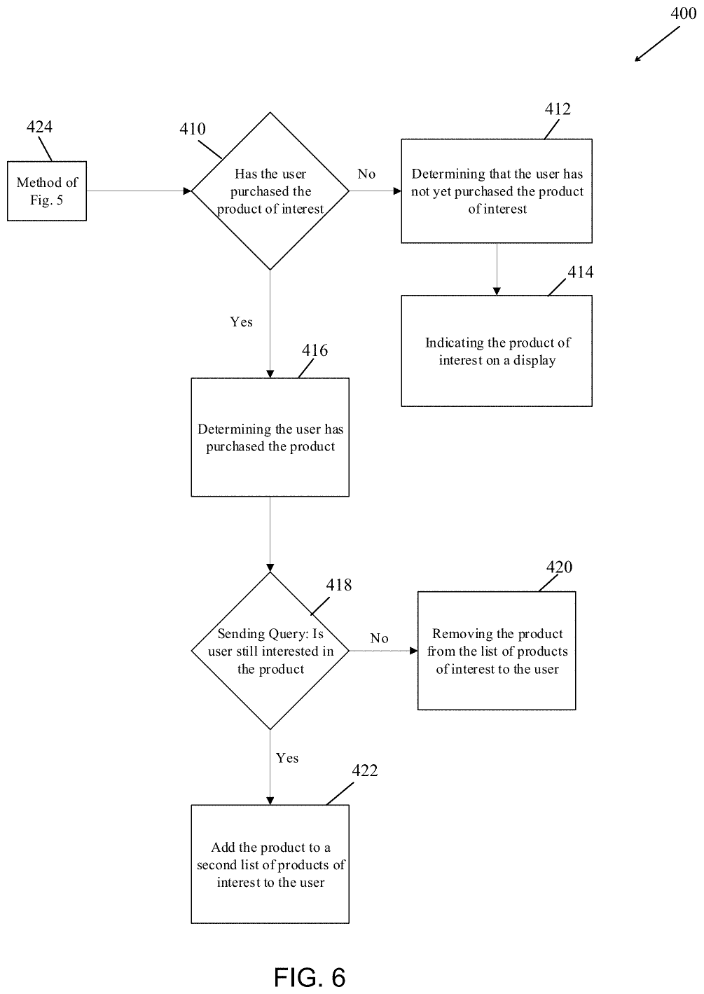

FIG. 6 depicts a flow chart of a method 400 for executing digital actions in a retail environment, in accordance with embodiments of the present invention. The method 400 may be a continuation of method 300 if the method 300 determines that the user has visited the retail environment previously in one embodiment. In another embodiment, the method 400 may be an independent method having steps that supplement and/or occur in conjunction with the method 300.

The method 400 may include a step 410 of determining whether the user has purchased the product of interest. The method 400 may thus include a step 412 of determining that the user has not yet purchased the product of interest by, for example, the analytics module 133. If this has been determined, the method 400 may include a step 414 of indicating the product of interest on a display of a mobile device such as the mobile device 110. The method 400 may include the additional step 318 of determining the product of interest based on the location of the user proximate the product of interest, as described hereinabove in the method 300.

The method may contain a step 416 of determining that the user has already purchased the product of interest. Again, the method 400 may include step 318 of determining the product of interest based on the location of the user proximate the product of interest, as described hereinabove in the method 300. If the method 400 determines that the user has already purchased the product of interest, the method 400 may include a step 418 of sending a query by, for example, the notification module 134 to the user that includes providing the user with an option to add the product of interest to the user to a second list of products of interest to the user in response. If the answer to the query is no, the method 400 may include the step 420 of automatically removing the product from the list of products of interest to the user, by for example, the analytics module 133 providing a removal command or request to the digital shopping platform 112. If the answer to the query is yes, the method 400 may include the step 422 of adding the product of interest to a second list of products of interest.

Advantageously, the present invention significantly simplifies the process for a user to add a product the user is considering in a physical retail environment to a digital wish list, shopping cart or even purchase a product in a digital shopping platform. The processes and system described herein saves users significant time. Further, because the system automatically locates the correct product being considered physically in a digital form, the present systems and methods eliminate the possibility that the user locates the incorrect product that does not correspond to the physical product that the user is considering. Still further, the present methods allow for a user to create a digital registry or wish list without the need for additional devices beyond the user's own mobile device. Thus, the systems and methods disclosed herein eliminate the need for additional devices such as UPC scanning devices, when setting up a registry or wish list in a retail environment. Still further, the present methods and systems provide significant improvement and eliminate the need for employee interaction with a customer looking to purchase goods at retail stores or venues that only display floor models to customers but require digital deliverable purchases. Further, the present invention results in improvements in computer technology by reducing computer resource usage because multiple steps will not need to be performed to accomplish the update of the wish list of a user, or purchase of a product.

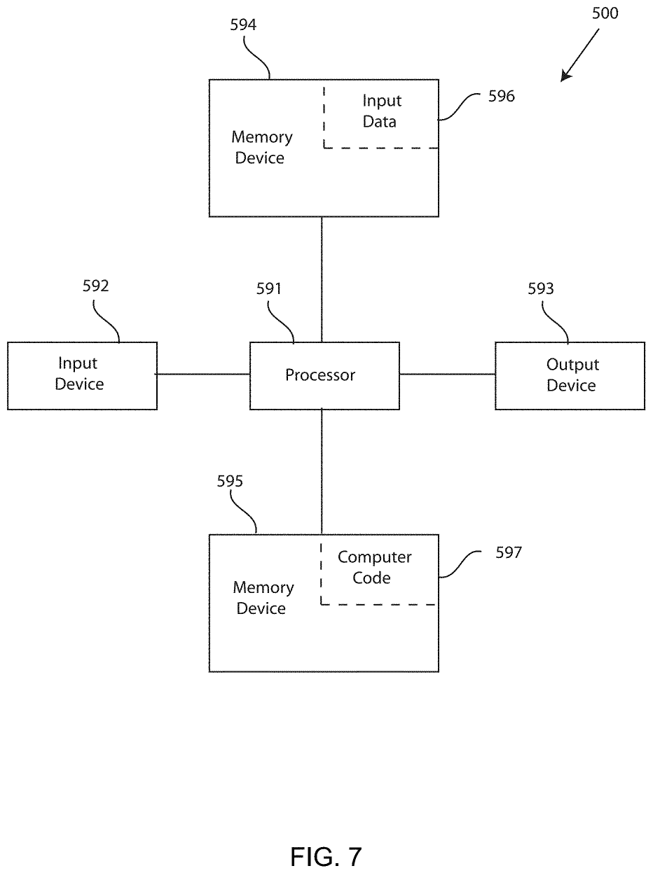

FIG. 7 illustrates a block diagram of a computer system for the system for executing digital actions in a retail environment of FIGS. 1-2, capable of implementing methods for for executing digital actions in a retail environment of FIGS. 5-6, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for executing digital actions in a retail environment, in the manner prescribed by the embodiments of FIGS. 5-6 using the system for executing digital actions in a retail environment of FIGS. 1-2, wherein the instructions of the computer code 597 may be executed by processor 591 via memory device 595. The computer code 597 may include software or program instructions that may implement one or more algorithms for implementing the methods f for executing digital actions in a retail environment, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 7.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for executing digital actions in a retail environment. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide a system for executing digital actions in a retail environment. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for executing digital actions in a retail environment. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for executing digital actions in a retail environment.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

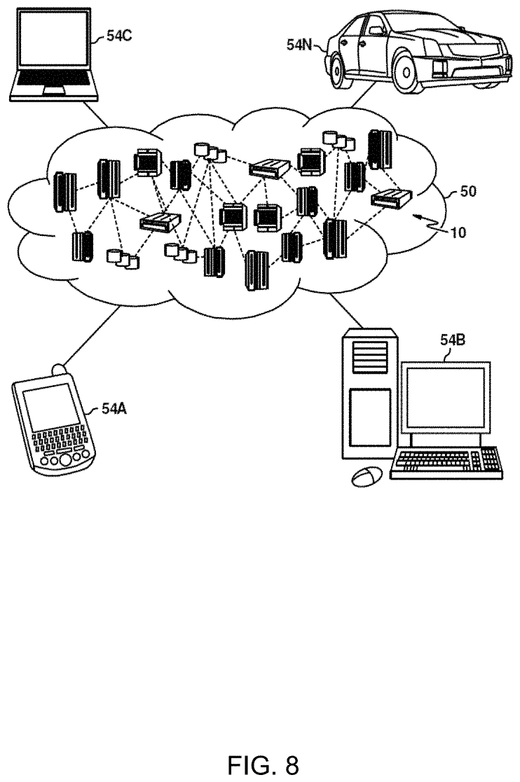

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 8 are intended to be illustrative only and that computing nodes 10 and cloud computing environment 50 can communicate with any type of computerized device over any type of network and/or network addressable connection (e.g., using a web browser).

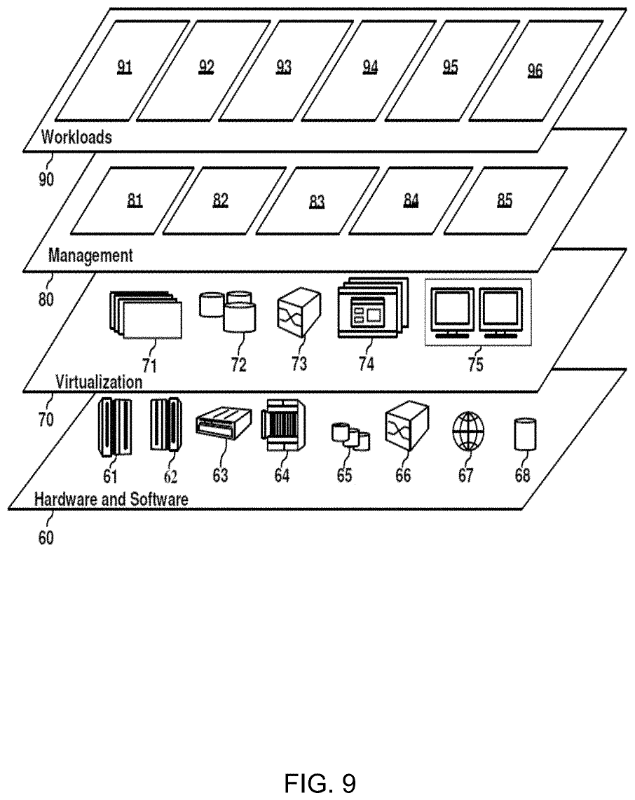

Referring now to FIG. 9, a set of functional abstraction layers provided by cloud computing environment 50 (see FIG. 8) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing of digital actions in a retail environment 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of executing a digital action in a retail environment, the method comprising:
receiving, by one or more processors of a computer system, information related to a location or orientation of a user in a retail environment;
determining, by the one or more processors of the computer system, the location or orientation of the user;
determining, by the one or more processors of the computer system, a product of interest for the user based at least in part on the location or orientation of the user, wherein the determining occurs during a first visit by the user to the retail environment; and
adding, by the one or more processors of the computer system, the product of interest to the list of products of interest to the user based on the received request.

2. The method of claim 1, further comprising:
presenting, by the one or more processors of the computer system via a display before adding the product of interest to the list of products of interest to the user, the user with a graphical user interface option to add the product of interest to the list of products of interest to the user; and
receiving, by the one or more processors of the computer system, a request to add the product of interest to the list of products of interest to the user.

3. The method of claim 2, further comprising:
determining, by the one or more processors during a second visit by the user to the retail environment, that the user has not yet purchased the product of interest; and
indicating, by the one or more processors via the display, the product of interest in response to the determining that the user has not yet purchased the product of interest during the second visit to the retail environment by the user.

4. The method of claim 2, further comprising waiting until the user is within a predetermined distance of the product to remind them of the item on the wish list.

5. The method of claim 1, further comprising:
determining, by the one or more processors, that the user has purchased the product; and
automatically removing the product from the list of products of interest to the user.

6. The method of claim 1, further comprising generating a map of the venue, by the one or more computer processors, that indicates locations of one or more products of interest.

7. The method of claim 1, further comprising determining a selection, by the one or more computer processors, of an item for inclusion in the list of products of interest to the user based on the determination that the mobile device has been held within a threshold distance to a product for a predetermined period of time by the user or the product has been interacted with for a predetermined period of time by the user.

8. A computer system, comprising:
one or more processors;
one or more memory devices coupled to the one or more processors; and
one or more computer readable storage devices coupled to the one or more processors, wherein the one or more storage devices contain program code executable by the one or more processors via the one or more memory devices to implement a method of executing a digital action in a retail environment, the method comprising:
receiving, by the one or more processors of the computer system, information related to a location or orientation of a user in a retail environment;
determining, by the one or more processors of the computer system, the location or orientation of the user;
determining, by the one or more processors of the computer system, a product of interest for the user based at least in part on the location or orientation of the user, wherein the determining occurs during a first visit by the user to the retail environment; and
adding, by the one or more processors of the computer system, the product of interest to the list of products of interest to the user based on the received request.

9. The computer system of claim 8, the method further comprising:
presenting, by the one or more processors of the computer system via a display before adding the product of interest to the list of products of interest to the user, the user with a graphical user interface option to add the product of interest to the list of products of interest to the user; and
receiving, by the one or more processors of the computer system, a request to add the product of interest to the list of products of interest to the user.

10. The computer system of claim 9, the method further comprising:
determining, by the one or more processors during a second visit by the user to the retail environment, that the user has not yet purchased the product of interest; and
indicating, by the one or more processors via the display, the product of interest in response to the determining that the user has not yet purchased the product of interest during the second visit to the retail environment by the user.

11. The computer system of claim 10, the method further comprising waiting until the user is within a predetermined distance of the product to remind them of the item on the wish list.

12. The computer system of claim 8, the method further comprising:
determining, by the one or more processors, that the user has purchased the product; and
automatically removing the product from the list of products of interest to the user.

13. The computer system of claim 9, the method further comprising generating a map of the venue, by the one or more computer processors, that indicates locations of one or more products of interest.

14. The computer system of claim 13, the method further comprising determining a selection, by the one or more computer processors, of an item for inclusion in the list of products of interest to the user based on the determination that the mobile device has been held within a threshold distance to a product for a predetermined period of time by the user or the product has been interacted with for a predetermined period of time by the user.

15. A computer program product, comprising a computer readable hardware storage device storing a computer readable program code, the computer readable program code comprising an algorithm that when executed by one or more processors of a computer system implements a method for of executing a digital action in a retail environment, the method comprising:
receiving, by the one or more processors of the computer system, information related to a location or orientation of a user in a retail environment;
determining, by the one or more processors of the computer system, the location or orientation of the user;
determining, by the one or more processors of the computer system, a product of interest for the user based at least in part on the location or orientation of the user, wherein the determining occurs during a first visit by the user to the retail environment, and
adding, by the one or more processors of the computer system, the product of interest to the list of products of interest to the user based on the received request.

16. The computer program product of claim 15, the method further comprising:
presenting, by the one or more processors of the computer system via a display before adding the product of interest to the list of products of interest to the user, the user with a graphical user interface option to add the product of interest to the list of products of interest to the user; and
receiving, by the one or more processors of the computer system, a request to add the product of interest to the list of products of interest to the user.

17. The computer program product of claim 16, the method further comprising:
determining, by the one or more processors during a second visit by the user to the retail environment, that the user has not yet purchased the product of interest; and
indicating, by the one or more processors via the display, the product of interest in response to the determining that the user has not yet purchased the product of interest during the second visit to the retail environment by the user.

18. The computer program product of claim 15, the method further comprising waiting until the user is within a predetermined distance of the product to remind them of the item on the wish list.

19. The computer program product of claim 15, the method further comprising generating a map of the venue, by the one or more computer processors, that indicates locations of one or more products of interest.

20. The computer program product of claim 19, the method further comprising determining a selection, by the one or more computer processors, of an item for inclusion in the list of products of interest to the user based on the determination that the mobile device has been held within a threshold distance to a product for a predetermined period of time by the user or the product has been interacted with for a predetermined period of time by the user.
